(19) United States
(12) Patent Application Publication
(10) Pub. No.: US 2008/0234080 A1
(43) Pub. Date: Sep. 25, 2008

(54) Motorcycle wheel isolator

(76) Inventors: Xinjian Fan, Novi, MI (US); Jing Yuan, Rochester Hills, MI (US); Lin Zhu, Rochester Hills, MI (US); Yuding Feng, Rochester Hills, MI (US)

Correspondence Address: THE GATES CORPORATION, IP LAW DEPT. 10-A3, 1551 WEWATTA STREET, DENVER, CO, 80202, US

(21) Appl. No.: 11/726,091

(22) Filed: Mar. 21, 2007

(51) Int. Cl. F16D 3/50

(52) U.S. Cl. 474/94

(57) ABSTRACT

A motorcycle wheel isolator comprising a first sprocket member, the first sprocket member having a first projecting member, a second hub member, the second hub member having a second projecting member, at least one first projecting member disposed between two second projecting members, whereby a receiving portion is defined, at least one resilient isolator having a first portion and a second portion connected by a connecting member, the resilient isolator disposed in the receiving portion, an edge of each first portion and second portion having a chamfer disposed adjacent either the first projecting member or second projecting member, each first portion and second portion having a projecting member disposed on an outer surface of each first portion and second portion such that a compressive force applied to the first portion and second portion causes a bending mode in each first portion and second portion, and each first portion and second portion having a relief portion disposed on an outer surface of each first portion and second portion such that the first portion and second portion may expand under the compressive force.

### FIELD OF THE INVENTION

The invention relates to a wheel isolator, and more particularly, to a motorcycle wheel isolator comprising resilient members having relief features and projecting bending mode members.

### BACKGROUND OF THE INVENTION

Isolators are used in motorcycle rear wheel drives in order to reduce the noise, vibration and harness (NVH) that may otherwise be transmitted to the rider.

Representative of the art is U.S. Pat. No. 6,516,912 B2 which discloses a power transmission mechanism into which a driven flange is assembled, the power transmission mechanism producing no metal contact noises. A driven flange is divided into an engine side flange and a wheel side flange. The engine side flange may be formed of a steel forging and the wheel side flange may be formed of an aluminum forging. The engine side flange is spline-fitted in a final gear integrally rotated with a bevel gear. Furthermore, openings are formed in the wheel side flange at equal intervals and blocks having a threaded hole therein are pressed into the openings. In addition, the engine side flange, the wheel side flange, and the blocks are integrally connected together with bolts.

What is needed is a motorcycle wheel isolator comprising resilient members having relief features and projecting bending mode members. The present invention meets this need.

### SUMMARY OF THE INVENTION

The primary aspect of the invention is to provide a motorcycle wheel isolator comprising resilient members blocks having relief features and projecting bending mode members.

Other aspects of the invention will be pointed out or made obvious by the following description of the invention and the accompanying drawings.

The invention comprises a motorcycle wheel isolator comprising a first sprocket member, the first sprocket member having a first projecting member, a second hub member, the second hub member having a second projecting member, at least one first projecting member disposed between two second projecting members, whereby a receiving portion is defined, at least one resilient isolator having a first portion and a second portion connected by a connecting member, the resilient isolator disposed in the receiving portion, an edge of each first portion and second portion having a chamfer disposed adjacent either the first projecting member or second projecting member, each first portion and second portion having a projecting member disposed on an outer surface of each first portion and second portion such that a compressive force applied to the first portion and second portion causes a bending mode in each first portion and second portion, and each first portion and second portion having a relief portion disposed on an outer surface of each first portion and second portion such that the first portion and second portion may expand under the compressive force.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIGS. 1(a) and 1(b) illustrate the prior art.

FIGS. 2(a), 2(b) and 2(c) illustrate the compound bending mode, where the three-point bending is achieved in the width direction (W) and two-point bending in the length direction (L).

FIGS. 3(a), 3(b) and 3(c) shows simple two-point bending mode in the length direction L.

FIG. 4 is a perspective view of a resilient block assembly.

FIG. 5 is a perspective view of the inventive isolator.

FIG. 6 is a detail of the isolator assembly.

FIG. 7 is an alternate embodiment.

FIG. 8 is a side view of an isolator assembly 10.

FIG. 9 is a top view of the resilient block assembly shown in FIG. 5.

FIG. 10 is an end view from 7-7 in FIG. 9.

FIG. 11 is an exploded view of the wheel sprocket isolator.

### DETAILED DESCRIPTION OF THE PREFERRED EMBODIMENT

The inventive motorcycle rear wheel isolator filters or reduces torsional vibration and torsional impact load during motorcycle operation and gear shifting. The benefit of the isolator is best illustrated during the dynamic transient events, namely transmission speed shifting, such as high speed downshifting and hard launch. In those events, the impact shock load (torque) can be absorbed by the soft rubber cushion blocks. However, the difficulty of proper isolator design is its competing targets, namely, the low torsional stiffness and low axial force.

Since the rubber elastomeric material is substantially incompressible, a low torsional stiffness implies a large axial displacement under high impact torque. In this condition, the rubber isolator is compressed in the tangential direction and will flow to expand in the other dimensions, i.e., radial and axial directions. Expansion in the axial direction will be detrimental to the axle bearing life. This is because the isolator bearing is selected mainly to undertake the hubload induced by the belt tension (tangential load), while its axial force limit is relative low. The axial load is oriented parallel to a wheel axis. An improper isolator design will typically lead to premature axle bearing failure due to excessive axial force.

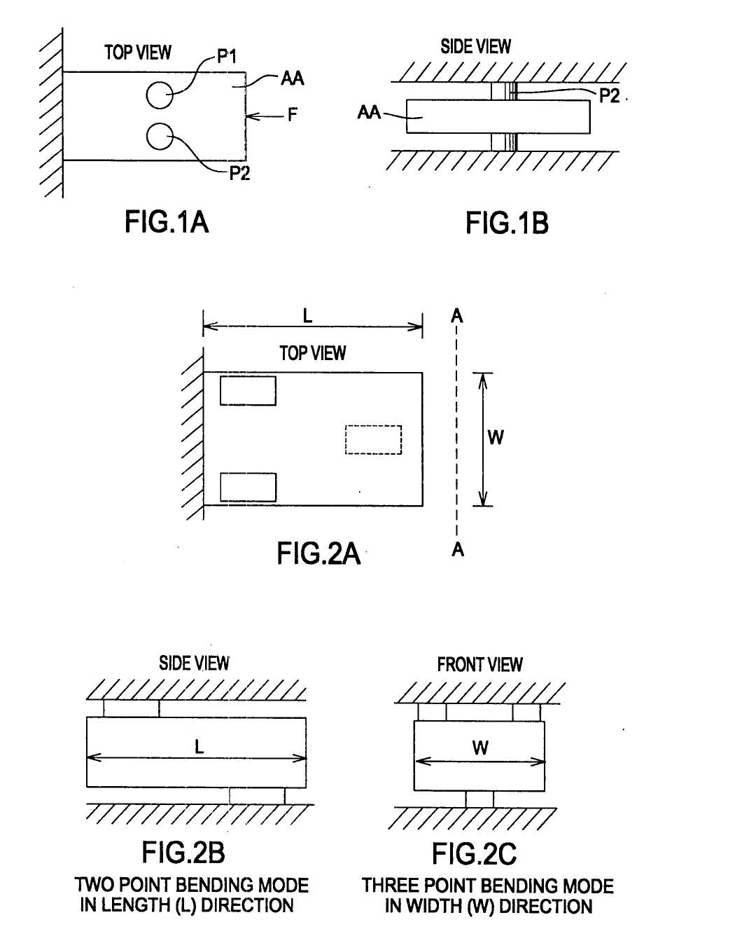

The other requirement is durability. In the case of a soft (low modulus) rubber isolator, rubber deformation and strain will be significant, resulting in a shorter operating life. For example, conventional isolator design places locating pins P1 and P2 adjacent to each other, as schematically shown in FIGS. 1(a) and 1(b). Under a compressive load F, axial expansion of the block AA will result in a compression mode at the pin pair P1, P2.

The principle of the inventive isolator is to switch the axial force from the compression mode into a bending mode since the force created by the bending moment is much less than its compression counterpart.

FIGS. 2(a), 2(b) and 2(c) illustrate the compound bending mode where the three-point bending is achieved in the width direction (W) and two-point bending in the length direction (L). This configuration is the most effective means to reduce the axial force where the overall length L dimension is limited.

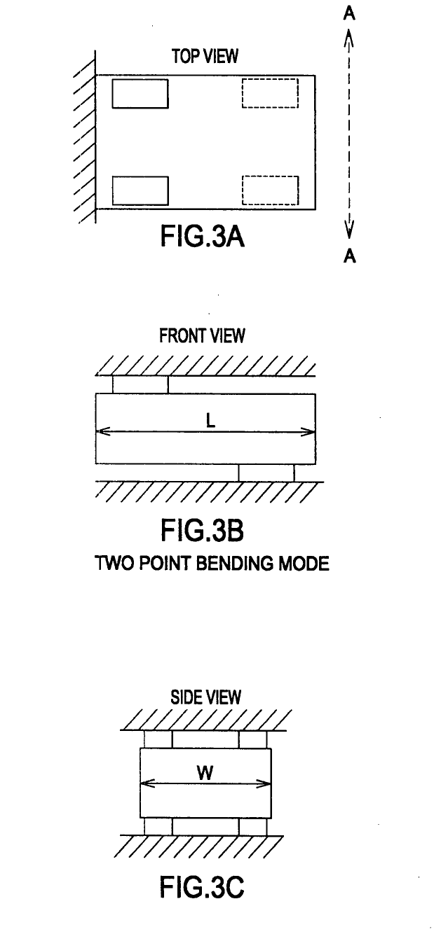

FIGS. 3(a), 3(b) and 3(c) shows simple two-point bending mode in the length direction L. Although this arrangement increases the stability of the rubber isolator part it requires somewhat more space in the length direction than the mode in FIG. 2(b) in order to make the bending mode more effective.

Up to a 50% axial force reduction can be achieved by using the bending mode approach described in this specification. The axial force operates along axis A-A in each of FIGS. 2 and 3.

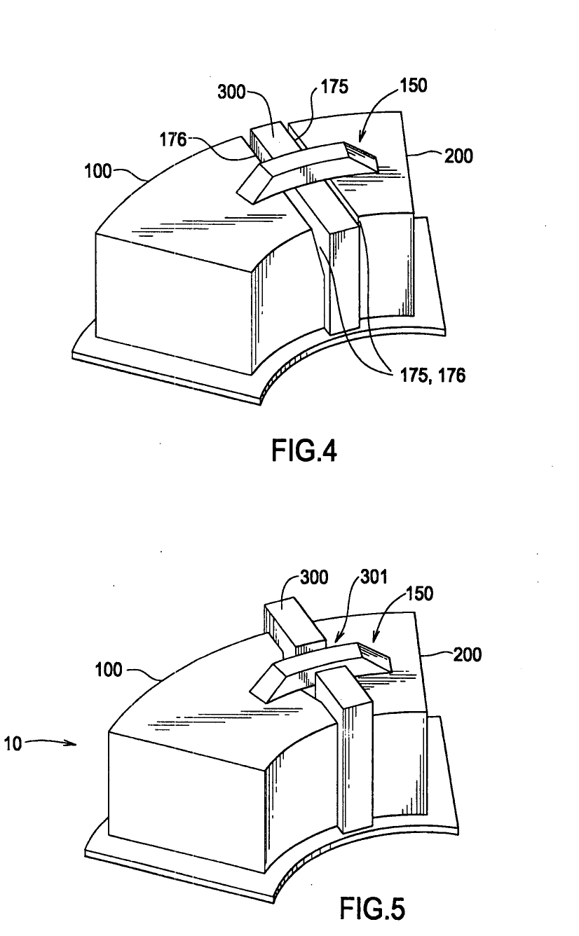

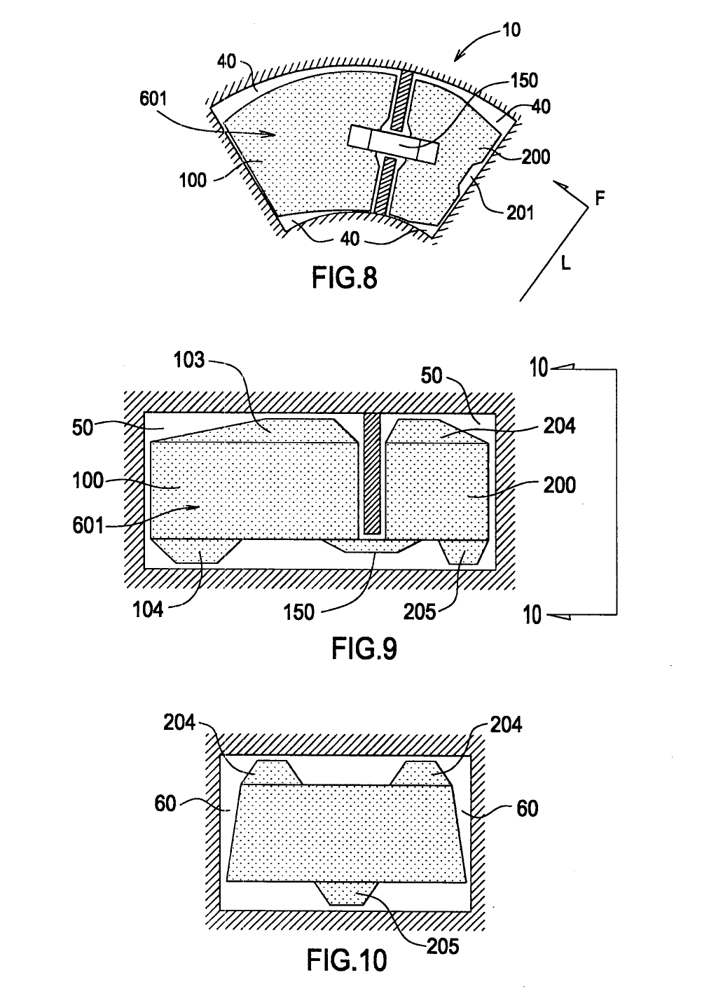

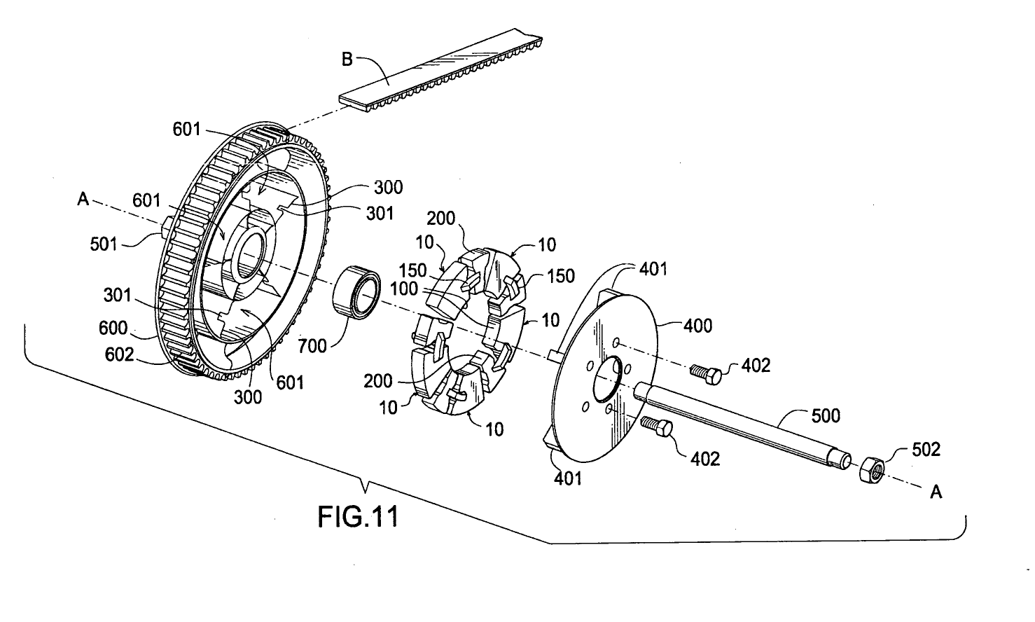

FIG. 4 is a perspective view of a resilient block assembly. The complete isolator comprises a plurality of resilient rubber isolator block assemblies 10, see FIG. 8. First block 100 is larger than second block 200 since first block 100 is configured for forward driving of a vehicle. Second block is for reverse driving of a vehicle, for example, during downshift events. A projecting member 300 is engaged between the first and second blocks, see FIG. 11.

An important aspect of the inventive isolator is how the projecting members come into contact with the resilient element 10 under compressive load. This is in addition to the bending mode and relief features described herein. The prior design has a drawback that the projecting member edge will cut into resilient block under a compressive load, ultimately leading to a crack in blocks 100, 200. To avoid this, the inventive isolator has three solutions.

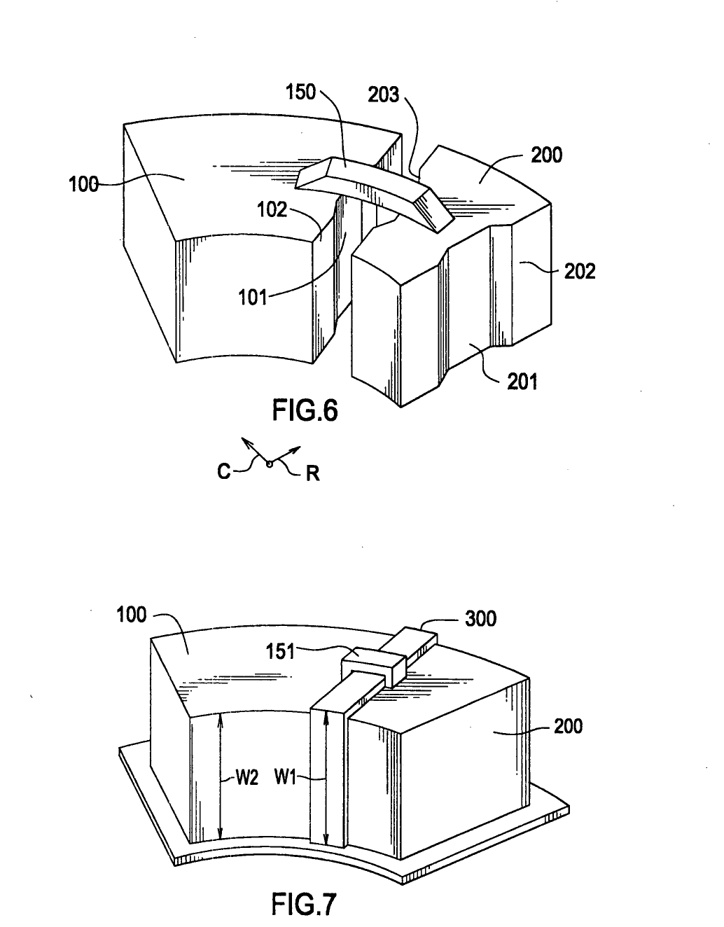

First, in order to prevent pinching the bottom corners of each block 100, 200, a chamfer 175, 176 is used to prevent bottom edge contact with projecting member 300 or projecting member 401, see FIG. 11 and FIG. 4. Next, concave recesses adjacent to the connecting member 150 combined with recesses in the projecting member, see FIGS. 5 and 6. Last, connecting member 150 which extends over the projecting member, see FIG. 7. Each of these features may be used singularly or in combination.

FIG. 5 is a perspective view of the inventive isolator. The isolator comprises a plurality of resilient blocks, see FIG. 11. FIG. 5 depicts a detail of two blocks. First block 100 and second block 200. As noted, first block 100 is larger than second block 200 since first block 100 is configured for forward driving of a vehicle. Second block 200 is for reverse driving load of a vehicle, for example, during downshift events. A metal projecting member 300 is engaged between the first and second blocks.

Recess 301 is disposed at the top of each projecting member 300 to form a drop bridge. Connector member 150 is situated between first block 100 and second block 200. Connector member 150 joins first block 100 to second block 200 by extending through the recess 301. Connector member 150 comprises the same material as block 100 and block 200.

Blocks 100, 200 compositions may comprise suitable natural or synthetic rubbers, including the following or a combination of two or more.

(1) Traditional diene elastomers such as NR, BR, SBR, IIR, CR and NBR. As is known in the art, they are generally vulcanized by means of heat-activated cure systems comprising sulfur and sulfur-based cure accelerators. However, rubber formulated with these elastomers are limited in terms of heat resistance and ozone resistance; or,
(2) Higher performance elastomers such as EPM, EPDM, HNBR, AEM, fluoro- and silicone rubbers. EPM and EPDM, members of the ethylene-alpha-olefin family of elastomers, are desirable for vibration isolators because of their high heat resistance, ease of incorporating fillers, and relatively low cost.

The elastomer compounds may also include reinforcement additives, such as carbon black fillers, antioxidants, internal lubricants to lower compound friction co-efficiency and curatives, each is known in the art. Curatives may include sulfur-based cure accelerators, peroxides or metal oxides.

FIG. 6 is a detail of the isolator assembly. Concave recess 201 is disposed on an outer surface of block 200. Concave recess 203 is disposed on an outer surface of block 200, substantially opposite recess 201. Concave recess 101 is disposed on an outer surface of block 100 substantially opposite concave recess 203.

Concave recesses 101, 201, 203 extend substantially normal to a radius R originating at a center of curvature C. Concave recesses 101, 201, 203 provide a means by which block 200 may expand when subjected to a compressive load, for example, during a downshift. Further, the pair concave recesses 201, 203 on the second block 200 creates two separated loading paths that minimizes the force transferred in the middle section of second block 200 thereby reducing the block material flow under a compressive load.

By combining recess 301 with the connector member 150, the projecting member 300 extends beyond the full width of the block contact area. Hence, bottom corner pinching of each block 100 and 200 seen in prior art isolators is eliminated.

An alternate embodiment is shown in FIG. 7. Instead of utilizing a recess 301 on the projecting member 300, a connector 151 is used between the rubber blocks 100 and 200 which extends around projecting member 300. For this alternate embodiment recess 301 on the embodiment shown in FIG. 5 is omitted. Projecting member 300 width W1 is predetermined to prevent projecting member 300 from contacting wheel hub 400, and thereby leave sufficient clearance to prevent connector 151 from being damaged or pinched between sprocket 600 and wheel hub 400 during operation, see FIG. 11.

The concave recesses 101, 203 are also omitted. The width dimension W1 of the projecting member 300 is slightly greater than the width W2 of first block 100 prevent pinching block 100 and block 200 between adjacent metal paddles.

FIG. 8 is a side view of an isolator assembly 10 contained within a receiving portion 601, see FIG. 11. A reserved volume technique is also used in the inventive design. Relief features 40 disposed on outer surfaces of each block 100 and 200 are present in the compressive load or torque-free state. A torque (t) is the product of a force F acting over the moment arm L. The force F is the tangential load transmitted by a vehicle belt (B) engaged with the isolator sprocket, see FIG. 11.

Under the full torque condition, each relief feature 40 is “filled” by the material of blocks 100, 200 as each block 100, 200 expands under the compression. The detail shape of each relief feature may be further refined based upon the maximum torque and the overall geometry cavity created between the wheel and the sprocket. This technique reduces the isolator torsional stiffness thereby making the isolator more efficient and durable.

FIG. 9 is a top view of the isolator assembly shown in FIG. 5 and FIG. 8. Relief features 50 are disposed between blocks 100, 200 and the sides of receiving portion 601, see FIG. 11. Receiving portion 601 is disposed in sprocket 600, see FIG. 11.

Projecting members 204 and 205 allows block 200 to “stand-off” from the receiving portion 601 compartment sides. Projecting members 103 and 104 allow block 100 to “stand-off” from the receiving portion 601 compartment sides. Each of the projecting members 204, 205, 103, 104 and the position of each causes each block 100 and block 200 to be subjected to a bending moment as described in FIGS. 2 and 3.

FIG. 10 is an end view from 10-10 in FIG. 9. Relief features 60 have the same purpose as relief features 40 and 50, namely, the blocks 100, 200 expand into the relief features 40, 50, 60 under compressive load. Due to the curvature of the isolator in receiving portion 601, connector member 150 is not shown in this view.

FIG. 11 is an exploded view of the wheel sprocket isolator. A sprocket used on a motorcycle final drive comprises sprocket 600 which cooperatively engages wheel hub 400. Sprocket 600 comprises flat metal projecting members 300 which extend radially from axis or rotation A-A. Wheel hub 400 comprises flat metal projecting members 401 which extend radially from axis A-A.

Wheel hub 400 is fastened to a wheel (not shown) using fasteners 402. Fasteners 402 comprise bolts. Sprocket 600 is engaged with wheel hub 400 only by engagement of each isolator 10 and projecting members 300 and 401. Projecting members 300 and projecting members 401 interengage in an alternating manner. Receiving portions 601 are disposed within sprocket 600. Blocks 100, 200 occupy the receiving portions 601.

Torque is transmitted from sprocket 600 to wheel hub 400 through compression of isolators 10 as each isolator bears upon projecting members 300 and projecting members 401.

Axle 500 is connected to a motorcycle frame swingarm (not shown) in a manner known in the art using mounting nuts 501 and 502. Sprocket 600 rotates about axle 500 on sprocket bearing 700. A toothed belt B engages belt bearing surface 602.

In operation torque is transmitted from the engine transmission to sprocket 600 through belt B. Belt B applies a tangential force to sprocket surface 602. The tangential force compresses blocks 100 through projecting members 300. Blocks 100 in turn press upon projecting members 401 which drive wheel hub 400. In the downshift mode torque is transmitted from the wheel to the engine through blocks 200, thereby allowing engine compression braking.

Although a form of the invention has been described herein, it will be obvious to those skilled in the art that variations may be made in the construction and relation of parts without departing from the spirit and scope of the invention described herein.

We claim:

1. A motorcycle wheel isolator comprising:
a first sprocket member, the first sprocket member having a first projecting member;
a second hub member, the second hub member having a second projecting member;
at least one first projecting member disposed between two second projecting members, whereby a receiving portion is defined;
at least one resilient isolator having a first portion and a second portion connected by a connecting member, the resilient isolator disposed in the receiving portion;
an edge of each first portion and second portion having a chamfer disposed adjacent either the first projecting member or second projecting member;
each first portion and second portion having a projecting member disposed on an outer surface of each first portion and second portion such that a compressive force applied to the first portion and second portion causes a bending mode in each first portion and second portion; and
each first portion and second portion having a relief portion disposed on an outer surface of each first portion and second portion such that the first portion and second portion may expand under the compressive force.

2. The motorcycle wheel isolator as in claim 1, wherein:
the first projecting member further comprises a recess, through which recess the connecting member extends.

3. The motorcycle wheel isolator as in claim 1 further comprising a plurality of resilient isolators.

4. The motorcycle wheel isolator as in claim 1, wherein the first sprocket member comprises a surface for engaging a toothed belt.

5. The motorcycle wheel isolator as in claim 1, wherein:
the first portion and the second portion each further comprising a concave recess;
each concave recess being cooperatively disposed opposite each other; and
the connecting member disposed adjacent the concave recesses.
